(19) United States
(12) Patent Application Publication
(10) Pub. No.: US 2016/0073588 A1
(43) Pub. Date: Mar. 17, 2016

(54) Method of Applying Compost

(71) Applicant: Royal Organics, LLC, Richland, WA (US)

(72) Inventors: Thad Schutt, Richland, WA (US); Charles Graaff, Quincy, WA (US)

(21) Appl. No.: 14/486,862

(22) Filed: Sep. 15, 2014

(51) Int. Cl. A01G 1/00

(52) U.S. Cl. CPC A01G 1/001

(57) ABSTRACT

A method of applying compost to soil which enables a substantial reduction in the use of compost and/or fertilizer. The method may employ adding a compost to soil, wherein the compost is added in an amount of from about 40% to about 200% per weight of seed, and wherein the compost is added to the soil so that a portion of the amendment is from about 0 to about 2 inches from each seed. Alternatively, the compost may be added at an amount of from about 30 to about 100 lbs of compost per acre of soil.

### BACKGROUND

Fertilizer materials have been used to enhance plant growth for years. Fertilizer materials may be in the form of solids, semi-solids, slurry suspensions, pure liquids, aqueous solutions and gases, and may be introduced into a plant's environment in a number of different ways. However, fertilizer material ingredients, especially nitrates, can cause problems for natural habitats and problems for human health if they are washed off soil into watercourses or leached through soil into groundwater. Past methods have employed three to five tons or more of fertilizer per acre.

Even current methods employ a large amount of nitrogen and other chemicals. For example, a typical wheat fertilizer would include 90-120 units of nitrogen (“N”). Moreover, urea, for example, is about 45% nitrogen. Accordingly, one would apply 200-270 lbs of urea per acre to obtain the proper amount of N required, which would result in nitrate runoff. Moreover, phosphorous, nitrogen and oxygen molecules that enter streams, creeks and other bodies of water as a result of fertilizer runoff and leaching can result in fertilizing blooms of algae that deplete oxygen thereby choking living organisms and producing what are known as “dead zones.”

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A first embodiment concerns a method of amending soil. The method may include applying seed to an area of soil; and applying a compost to the area of soil. Moreover, the compost may be added at an amount of from about 40% to about 200% per weight of seed. Alternatively or in addition to, the compost may be added to the soil so that at least a portion of the compost is from about 0 to about 2 inches from each seed.

Another embodiment concerns a method of amending soil. The method may include applying seed to an area of soil; and applying a compost to the area of soil at an amount of from about 30 to about 100 lbs per acre of soil. Moreover, the compost may be added to the soil so that at least a portion of the compost is from about 0 to about 2 inches from each seed.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a flowchart illustrating an embodiment of a method of applying a compost to soil.

FIG. 2 illustrates a flowchart illustrating another embodiment of a method of applying a compost to soil.

FIG. 3 shows an example device for applying a compost and seeds to soil.

FIG. 4 shows a bar graph which illustrates the results of a wheat crop (in bushels per acre and increased net income) grown under various compost pellet and/or fertilizer regimes.

FIG. 5 is a bar graph which illustrates the results of a wheat crop grown with compost pellets or fertilizer.

### DETAILED DESCRIPTION

According to an embodiment, the present invention concerns a method of applying a compost to plants or crops. The compost may be applied at a substantially reduced amount as compared to traditional practices. According to another embodiment, the compost may be applied to soil along with a fertilizer which enables a substantial reduction in the amount fertilizer applied to soil for crop growth thereby substantially reducing fertilizer run-off and leaching. While fertilizers are generally recognized as being chemical in nature, the composts described herein are organic and non-chemical. Moreover, because the composts described herein are organic in nature, the composts resist runoff thereby greatly reducing the amount of material that leaches into waterways and sources of groundwater. The methods described herein use a substantially reduced amount of compost and/or fertilizer while resulting in substantially the same or improved crop yield over traditional composting and/or fertilizing crop growth methods. According to certain embodiment, the methods described herein provide a crop yield that is at least 5%, 10%, 15%, 20%, 25%, 30%, 35%, 40%, 45%, 50% or greater than crop yields grown under traditional composting and/or fertilizing crop growth methods.

As used herein the term “compost” is meant to include any variety of organic material, which may be animal or vegetable in origin, and which through biological, such as microbial (bacterial, fungal, and actinomycetes) action under controlled conditions to promote aerobic decomposition. The organic material may be modified or converted to stable compost material for agricultural purposes.

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” “contain,” “including,” “includes,” “include,” and “have” have the same open-ended meaning as “comprising,” “comprises,” and “comprise” provided above.

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds) and provided literal support for and includes the end points of 10 and 100.

The present description uses specific numerical values to quantify certain parameters relating to the invention, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. These broad, intermediate, and narrow numerical ranges should be applied not only to the specific values, but should also be applied to differences between these specific values.

According to an embodiment, the method includes applying seed to an area of soil; and applying a compost to the area of soil. Moreover, the compost may be added at an amount from about 40% to about 200% per weight of seed. Alternatively or in addition to, the compost may be added to the soil so that at least a portion of the compost is from about 0 to about 2 inches from each seed.

According to another embodiment, the method includes applying seed to an area of soil; and applying a compost to the area of soil at an amount from about 30 to about 200 lbs per acre of soil. Moreover, the compost may be added to the soil so that at least a portion of the compost is from about 0 to about 2 inches from each seed.

According to certain embodiment, the compost may be liquid or a solid. Moreover, when solid, the compost may be in the form of a pellet. When in the form of a liquid, the compost may be about 5% to about 50% by weight percent of compost, about 10% to about 40% by weight percent of compost, or about 15% to about 30% by weight percent of compost. Alternatively, when in pelletized form, the pellets may be made via any known method. For example, the pellets may be made by charging a thick liquid of paste form of the compost into a hopper. The paste may then be extruded through a number of openings and cut to the desired size. The pellets may then be dried to a moisture content of less than about 15 wt percent. Care should be taken when drying so as not harm beneficial microbes in the pellets.

According to certain embodiments, the starting materials, which may be biologically decomposed to form the compost, may include but are not limited to yard waste (grass trimmings, leaves, prunings, etc.), food waste, wood waste, agricultural residues (mint, cull fruit, cull hop residue, grape pumice, etc.), manures, Biosolids, etc.

According to an embodiment, the compost may be added to the soil in an amount from about 40% to about 200%, from about 50% to about 100% or from about 60% to about 80% per weight of seed. Exemplary seeds may include, but are not limited to, grains, oilseeds, legumes vegetables, etc. For example, seeds may include but are not limited to, wheat, barley, corn, rye, soybeans, hay, alfalfa, cotton, sorghum rice, etc. In certain embodiments, when low volume seeds (e.g. less than 10 lbs per acre) are planted, such as for example canola or sunflower, the soil amendment may be added to soil in an amount of greater than 200%, 500%, 700%, 1000% or greater per weight of seed, Moreover, the amendment may be added to the soil so that at least a portion of the amendment is from about 0 to about 2 inches, from about 0.2 to about 1 inch or from about 0.25 to about 0.5 inch from each seed.

According to certain embodiment, the compost may be added separately and may be added to the soil before, during or after seeding. For example, the compost may be added during direct seeding of the seed wherein the compost is deposited in the soil before, at the same time, or after the seeds have been deposited into the soil.

According to certain embodiments, a chemical fertilizer, a mineral fertilizer, another compost or a mixture thereof is added to the soil before, after or while the compost is being added to the soil. In embodiments, where a fertilizer is applied in addition to the compost, the fertilizer may be added in amount that is about ⅓ to ½ times less than the amount of fertilizer that would be added if the fertilizer was added to the soil without the application of the compost while resulting in at least the same crop growth or yield. According to certain embodiments, applying a combination of the compost and a substantially reduced amount of fertilizer results in a crop yield that is at least 0%, 5%, 10%, 15%, 20% or greater than if the fertilizer was applied without the compost.

According to yet another embodiment, the method of amending soil may include applying a compost to soil at an amount from about 20 to about 100 lbs per acre of soil, from about 30 to about 75 lbs per acre of soil or from about 40 to about 50 lbs per acre of soil. Again, a substantially reduced amount of fertilizer as described above may also by applied with compost.

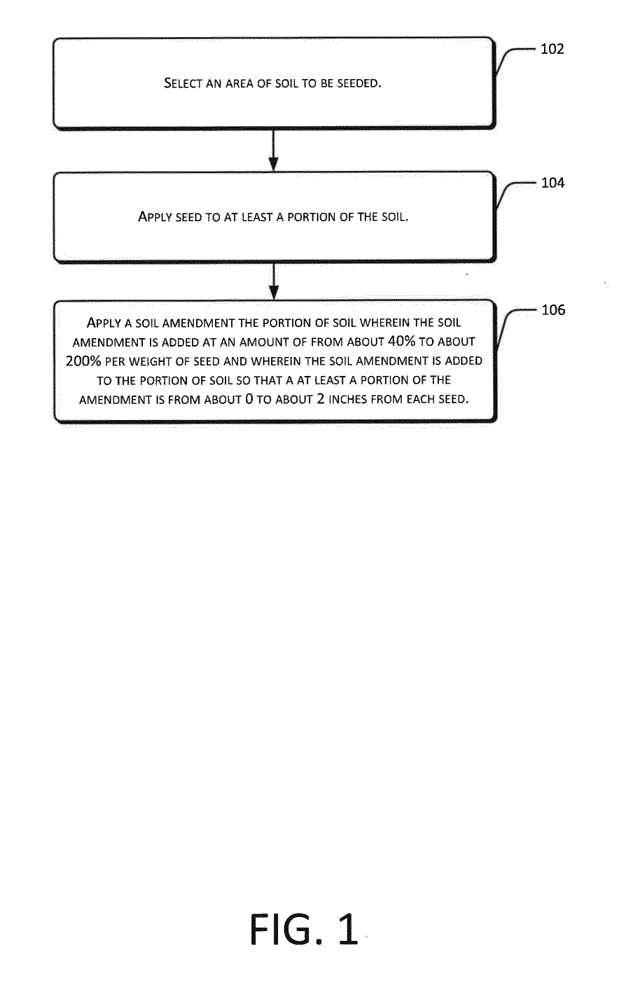

FIG. 1 illustrates an example method of amending soil. At 102, an area of soil to be seeded may be selected. At 104, seed may be applied to at least a portion of the area of soil selected in 102. As described above, the seed may be applied by any method. According to an embodiment, the seed may be applied to the soil via a direct seeding application. At 106, a compost mat be applied to the soil selected in 102. Moreover, the compost may be added at an amount from about 40% to about 200% per weight of seed and so that at least a portion of the compost may be from about 0 to about 2 inches from each seed. As also discussed above, the compost may be added before, during or after the seed is applied.

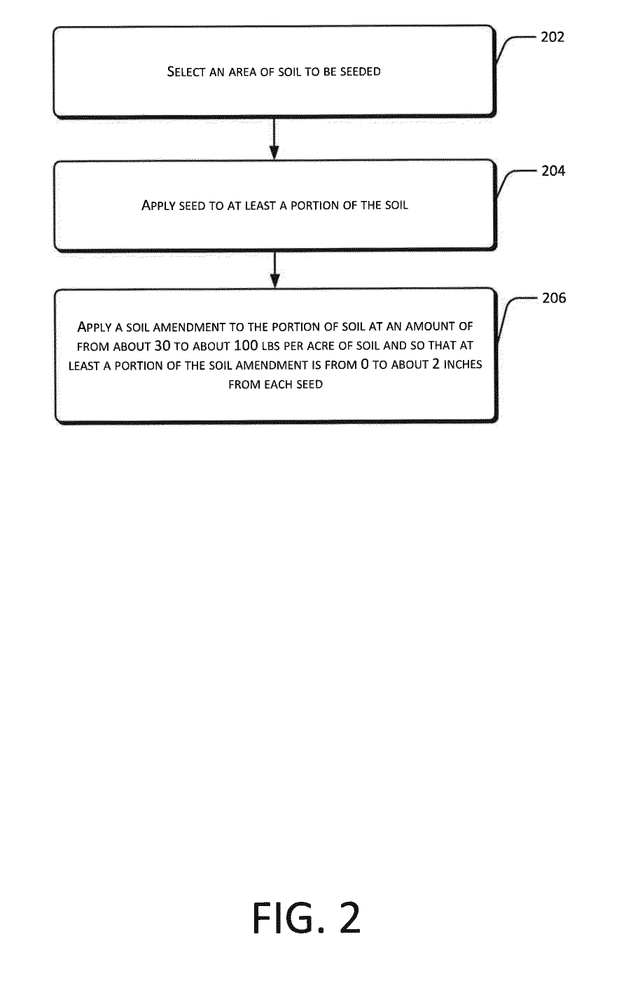

FIG. 2 illustrates another example of amending soil. At 202, an area of soil to be seeded may be selected. At 204, seed may be applied to at least a portion of the area of soil selected in 202. Again, the seed may be applied by any method. According to an embodiment, the seed may be applied to the soil via a direct seeding application. At 206, a compost may be applied to the soil selected in 102. Moreover, the compost may be applied at an amount from about 30 to about 200 lbs per acre of soil so that at least a portion of the amendment may be from about 0 to about 2 inches from each seed. Again, according to this example embodiment, the compost may be added before, during or after the seed is applied.

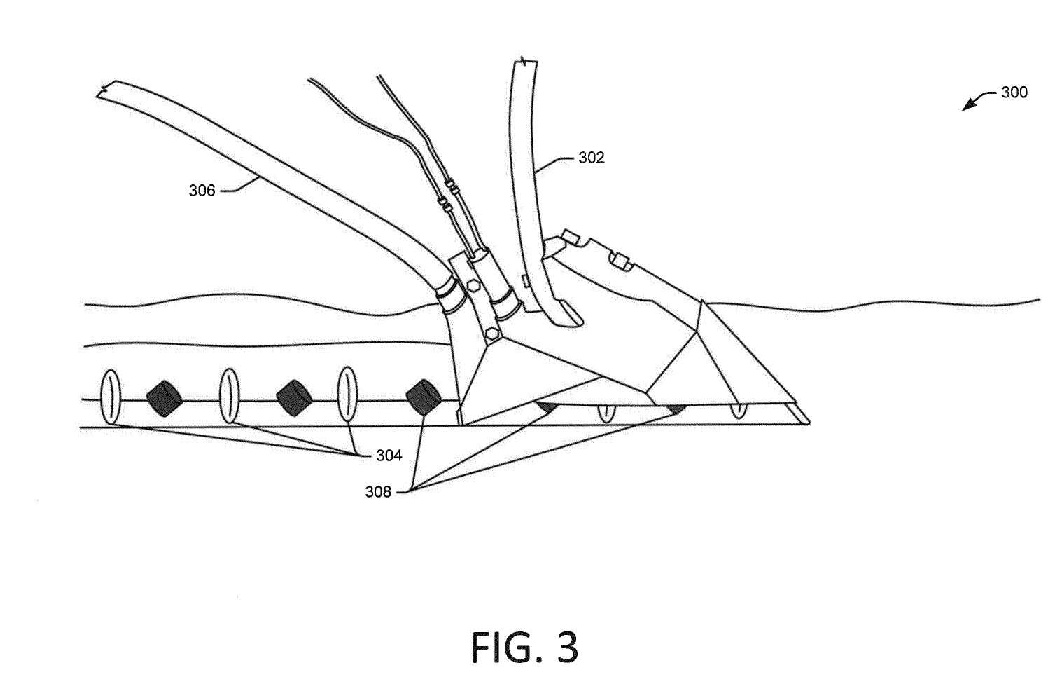

FIG. 3 illustrates and example application device 300 which is useful for applying seed and at least one compost as described herein. The application device 300 is designed so that it penetrates the top of the soil. The application device 300 includes a seed depositing tube 302 for depositing seed 304 and a compost depositing tube 306 for depositing a compost/and or fertilizer 308. FIG. 3 shows the compost 308 in pelletized form. However, the compost 308 could be in other forms such as for example a liquid.

### EXAMPLES

### Example 1

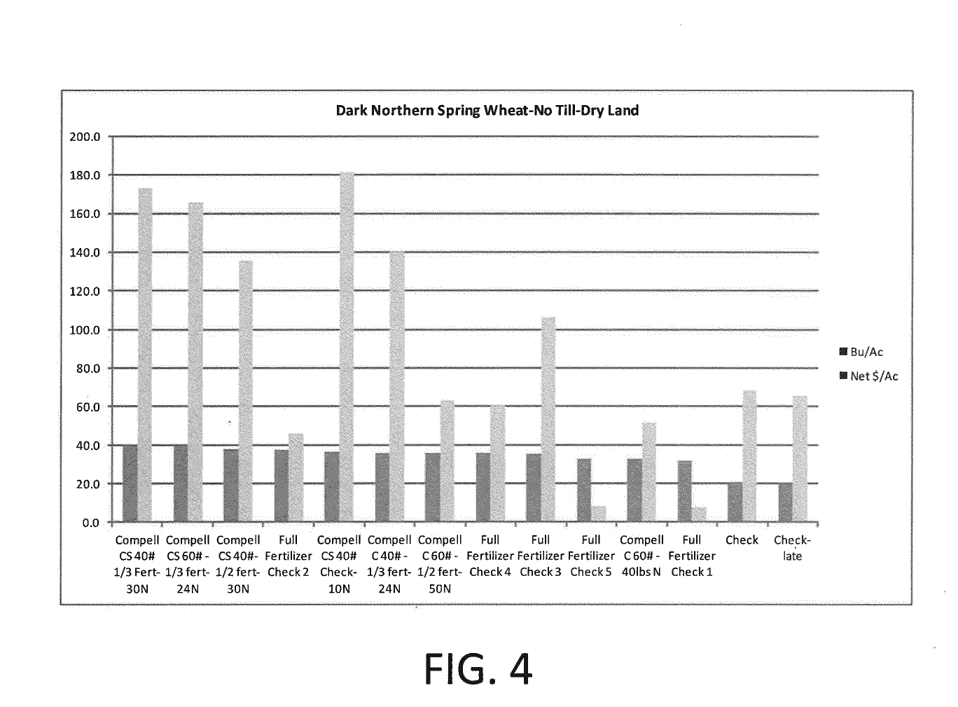

FIG. 4 shows the results of a field trial where plots of seeds were supplemented with multiple blends of compost pellets (at two different rates) with reduced amount of fertilizer or without fertilizer. Each experiment was replicated 3 times in multi-acre plots. The farm was located east of Reardon, Wash.

As shown on FIG. 4, certain plots were treated with 40 lbs of compost pellets per acre with the seed using a JD 752 single disc opener no-till drill. Other plots were treated with 40 lbs of compost pellets per acre and various reduced amounts of fertilizer. The seed was treated with a fungicide. The plots were seeded with 70 lbs/acre of Kelse variety of Dark Northern Spring Wheat. Moreover, the seeds and compost pellets were applied to the soil so that on average a compost pellet was about ¼ inches or less from a seed. Seeds were grown under normal condition to produce plots of wheat plants.

The results show that, while reducing fertilizer input, yields (Bushel/Acre) could be maintained or increased with a small amount of compost pellets or a small amount of compost pellets and a reduced amount of fertilizer. The results also show that net income per acre (Net $ acre) to a grower would dramatically increase due to the reduction of fertility input costs (reduction in use of fertilizer and/or compost) while maintaining yield.

Compost Pellet 40 lbs and 60 lbs 30% mint based soil supplement and 70% yard waste

Fertilizer—mixture of 40 lbs nitrogen, 20 lbs phosphorous, 1.5 lbs zinc and 1.46 lbs magnesium

Check—no fertilizer

### Example 2

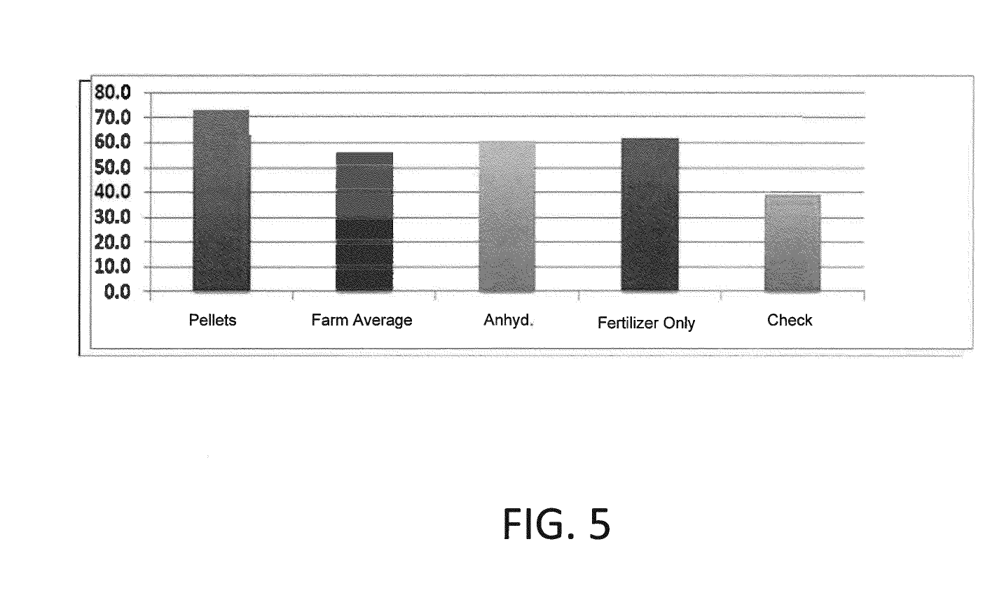

FIG. 5 shows the results of a field trial which compares plots of seeds that had undergone a standard fertilizer treatment that were supplemented with compost pellets and plots of seeds with the standard fertilizer treatment alone. Each experiment was replicated 3 times in multi-acre plots. The farm was located east of Reardon, Wash.

Each type of plot was replicated 3 times within the same field. All plots were treated with 90 lbs of N, 45 lbs S, and 1.5 lbs Zn per acre (representing a standard fertilizer treatment), except the check plot. Soil samples indicated adequate amounts of P and K in the soil profile so no additional amounts were applied. The plots with compost pellets used 40 lbs of compost pellets per acre and were applied along with the seed using a JD 752 single disc opener no-till drill. The seed was treated with a fungicide. The plots were seeded with 70 lbs/acre of Kelse variety of Dark Northern Spring Wheat.

The results show that the compost pellets, used as an amendment to a standard fertilizer treatment, increased yields by an average of about 19%. At $8/bushel this equates to about $96/acre increase in revenue with an increase of input costs of about $12/acre.

Compost pellets—30% mint based soil supplement and 70% yard waste

Anhyd—anhydrous ammonia

Fertilizer—mixture of 40 lbs nitrogen, 20 lbs phosphorous, 1.5 lbs zinc and 1.46 lbs magnesium

Check—no fertilizer

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of amending soil comprising:
applying seed to an area of soil; and
applying a compost to the area of soil,
wherein the compost is added at an amount of from about 40% to about 200% per weight of seed, and wherein the compost is added so that at least a portion of the compost is from about 0 to about 2 inches from each seed.

2. The method according to claim 1, wherein at least a portion of the compost is from about 0.2 to about 1 inch from each seed.

3. The method according to claim 2, wherein at least a portion of the compost is from about 0.25 to about 0.5 inch from each seed.

4. The method according to claim 1, wherein the compost is added at an amount of from 50% to about 200% per weight of seed.

5. The method according to claim 5, wherein the compost is added at an amount of from about 60% to about 80% per weight of seed.

6. The method according to claim 1, wherein the compost is added to the soil before, during or after seeding.

7. The method according to claim 1, wherein a chemical fertilizer, a mineral fertilizer, another compost or a mixture thereof is added to the soil.

8. The method according to claim 1, wherein the compost comprises pelletized compost.

9. The method according to claim 1, wherein the compost is a solid or a liquid.

10. A method of amending soil comprising:
applying seed to an area of soil; and
applying a compost to the area of soil at an amount of from about 30 to about 100 lbs per acre of soil,
wherein the compost is added to the area of soil so that at least a portion of the amendment is from about 0 to about 2 inches from each seed.

11. The method according to claim 10, wherein at least a portion of the compost is from about 0.2 to about 1 inch from each seed.

12. The method according to claim 11, wherein at least a portion of the compost is from about 0.25 to about 0.5 inch from each seed.

13. The method according to claim 10, wherein the compost is added to the area of soil at an amount of from about 30 to about 75 lbs per acre of soil.

14. The method according to claim 13, wherein the compost is added to the area of soil at an amount of from about 40 to about 50 lbs per acre of soil.

15. The method according to claim 10, wherein the compost is added to the soil before, during or after seeding.

16. The method according to claim 10, wherein a chemical fertilizer, a mineral fertilizer, another compost or a mixture thereof is added to the soil.

17. The method according to claim 10, wherein the compost comprises pelletized compost.

18. The method according to claim 10, wherein the compost is a solid or a liquid.
